(19) United States
(12) Patent Application Publication
(10) Pub. No.: US 2004/0194051 A1
(43) Pub. Date: Sep. 30, 2004

(54) Finite element modeling system and method for modeling large-deformations using self-adaptive rezoning indicators derived from eigenvalue testing

(76) Inventor: Bryan L. Croft, San Diego, CA (US)

Correspondence Address: OFFICE OF PATENT COUNSEL, SPAWARSYCEN, CODE 20012, 53510 SILVERGATE AVE. ROOM 103, SAN DIEGO, CA, 92152-5765, US

(21) Appl. No.: 10/845,447

(22) Filed: May 13, 2004

(51) Int. Cl. G06F 17/50

(52) U.S. Cl. 716/20

(57) ABSTRACT

A self-adaptive rezoning process that employs a system of rezoning indicators for the automated detection of distorted elements during deformation. Linear isoparametric quadrilateral elements using selective reduced integration are employed to predict the remeshing points based upon finite-element modeling assumptions of structural problems involving large deformations and strains. Element geometrical measures are characterized in terms of aspect ratio, taper ratio and skew angle to permit the degree of element distortion expressed in these terms to be compared to an ideal element similarly expressed. The finite-element mesh is evaluated, element by element, to quantify the geometrical relationships required to properly quantify the amount of distortion.

### STATEMENT OF GOVERNMENT INTEREST

The invention described herein may be manufactured and used by or for the Government of the United States of America for Governmental purpose without the payment of any royalties thereon or therefore.

### BACKGROUND OF THE INVENTION

1. Field of the Invention

This invention relates generally to finite element (FE) modeling systems and more particularly to a system for the adaptive remeshing of an FE model responsive to deformation.

2. Description of the Related Art

Finite element (FE) analysis is widely known in the mechanical engineering arts as a numerical approximation technique that divides a component or structure into discrete regions (the finite elements) joined by nodes and computing the response as described by a set of functions that represent the displacement or stresses in that region. The FE method provides a greater flexibility to model complex geometries than finite difference and finite volume methods do. It has been widely used in solving structural, mechanical, heat transfer and fluid dynamics problems as well as problems of other disciplines. The advancement in computer technology enables the solution of ever larger system of equations, the formulation and assembly of the discrete approximations and the display of graphical results quickly and conveniently. This has also helped the FE method become a powerful tool.

The usual FE analysis procedure includes the steps of dividing the component or structure into discrete elements, defining the geometrical and mechanical properties of each element, assembling the element stiffness matrices, applying known external loads at nodes joining elements, specifying component support conditions, solving the resulting system of simultaneous linear algebraic equations and calculating stresses (and strains) in each element. This is essentially an iterative discretization and approximation procedure wherein the solution at each point becomes the initial conditions for the next solution.

The FE method in recent decades has become a mainstay for industrial engineering design and analysis. Increasingly larger and more complex designs are being simulated using the FE method. With its increasing popularity comes the clearly-felt need for improved automatic meshing procedures.

Meshing denominates the process of breaking up a physical domain into smaller sub-domains (elements) to facilitate the numerical solution of a partial differential equation. While meshing may be used for a wide variety of applications, the principal application of meshing is in FE analysis. Surface domains may be subdivided into triangle or quadrilateral shapes, while volumes may be subdivided primarily into tetrahedra or hexahedra shapes, for example. The shape and distribution of the elements is preferably defined by some useful automatic meshing procedures.

Early users of the FE method were generally satisfied with using tens or hundreds of elements to simulate vastly simplified forms of their final design. This required painstaking manual preprocessing to subdivide domains into usable elements. The needs of the art have now pushed meshing technology to the point where users now expect to use thousands or millions of elements to mesh complex domains with no manual preprocessing.

FE practitioners in the aerospace and automotive industries have immediate needs to shorten design cycles and overall time to market. Improving the robustness, speed and quality of automatic meshers, while only a small part of the entire process, may translate into increased revenue and competitive advantage.

The specific meshing improvements sought in the art are diverse. Practitioners debate among themselves as to what shape of element produces the most accurate result. The quadrilateral and hexahedral shaped elements are believed by many to offer superior performance to triangle and tetrahedral shaped elements when employing an equivalent number of degrees of freedom. Use of hex elements may also vastly reduce the number of elements and the consequent analysis and post-processing times. Also, hex and quadrilateral elements are more suited for non-linear analysis and situations where alignment of elements is important to the physics of the problem, such as in computational fluid dynamics or simulation of composite materials.

The automatic mesh generation problem is that of attempting to define a set of nodes and elements to best describe a geometric domain, subject to various element size and shape criteria. Geometry is most often composed of vertices, curves, surfaces and solids as described by a CAD or solids modeling package.

Many applications, use a “bottom-up” approach to mesh generation. Vertices are first meshed, followed by curves, then surfaces and finally solids. The input for the subsequent meshing operation is the result of the previous lower dimension meshing operation.

For example, nodes are first placed at all vertices of the geometry. Nodes are then distributed along geometric curves. The result of the curve meshing process provides input to a surface meshing procedure, where a set of curves define a closed set of surface loops. Decomposing the surface into well-shaped triangles or quadrilaterals is the next phase of the meshing process. Finally, if a solid model is provided as the geometric domain, a set of meshed areas defining a closed volume is provided as input to a volume mesher for automatic formation of tetrahedra, hexahedra or mixed element types.

Although many take radically different approaches, the ultimate goal is to provide a mesh that may be used to solve a partial differential equation. This field is relatively new. Most of the papers published in this area have been within the past five to ten years. Many questions have been solved in this time, but there are still a significant number of problems to be addressed.

The FE analysis art is replete with incremental improvements to the meshing problem. For example, in U.S. Pat. No. 5,838,594, Kojima discloses a FE mesh generating method for generating triangular meshes for use in FE method analysis. Kojima's FE mesh generating method includes the steps of(a) inputting orthogonal meshes used in finite difference method and mesh joining conditions, (b) setting flags indicating candidates of lattice points which are to be deleted out of lattice points of the orthogonal meshes, based on the orthogonal meshes, (c) reducing a number of meshes by joining the lattice points having the set flag and lattice points adjacent thereto, based on the mesh joining conditions and (d) successively generating triangular meshes by searching nodes formed by lattice points remaining on the meshes after joining the lattice points and generating oblique sides of rectangles which are formed by connecting the nodes. Kojima discloses a meshing and post-processing method but neither considers nor suggests solutions to the dynamic remeshing problem of determining when to regenerate the FE mesh during the analysis process at large deformations.

In U.S. Pat. No. 5,768,156, Tautges et al. disclose a computer-based method and apparatus for constructing all-hexahedral FE meshes for FE analysis. Tautges et al. start with a three-dimensional (3-D) geometry and an all-quadrilateral surface mesh, construct hexahedral element connectivity from the outer boundary inward and finally resolve invalid connectivity, resulting in a complete representation of hex mesh connectivity only, leaving actual mesh node locations for later. Tautges et al. disclose an improvement to the step of forming hexahedral elements by making crossings of entities referred to as “whisker chords,” and combine this step with a seaming operation in space to provide a sufficient meshing system for simple block problems. Tautges et al. disclose a method for detecting invalid connectivity in space that is based on repeated edges that may be applied to resolve various invalid connectivity situations Tautges et al. neither consider nor suggest solutions to the problem of determining when and how to re-mesh the FE mesh responsive to large deformation conditions.

In U.S. Pat. No. 5,675,521, Holzhauer et al. disclose a method for performing thermal reliability analysis of electronic devices such as multichip modules by integrating traditional thermal analysis techniques, such as FE analysis with artificial intelligence techniques. Specifically, the use of object-oriented programming, blackboard architecture and knowledge sources based on expert systems allows the system to perform lower-level reasoning associated with the development of the FE mesh. The resulting mesh is examined to suggest how to form a better mesh and the meshing analysis is repeated using the improved mesh. Holzhauer et al. neither consider nor suggest solutions to the problem of when and how best to initiate FE remeshing during the FE analysis process. The main emphasis of the invention is the determination of when and how to re-mesh the FE mesh responsive to large deformation conditions.

In U.S. Pat. No. 5,402,366, Kihara et al. disclose a method and apparatus for simulating a mechanical operation based on the FE method and uses a particle flow model. Kihara et al. suggest that with their method, neither an evaluation of contact boundary between a die and a material nor a remeshing operation are necessary because particles are moved on fixed elements to reflect changes in material properties therein. Because their elements per se are not deformed, Kihara et al. does not perform any remeshing operations and therefore neither consider nor suggest solutions to the problem of triggering the regenerating FE meshes during the analysis process.

As part of the meshing problem, to avoid unacceptable discretization errors, a rezoning procedure is required whenever elements within a Lagrangian-based FE mesh become sufficiently distorted during modeling of large deformations and strains. Rezoning is a procedure that halts the usual finite-element solution process and corrects the distorted elements to avoid inaccuracies and ill-conditioning that would otherwise occur during subsequent solution processing. The solution process is restarted after remeshing and the remapping of the element variables in the rezoning regions. Until now in the art, the rezoning process has been implemented as an interactive process without attempting to use theory to predict remeshing points.

There is accordingly a clearly-felt need in the art for an automated rezoning procedure for revising and correcting distortions in the mesh during FE analysis of mechanical systems undergoing large strains and displacements. The related unresolved problems and deficiencies are clearly felt in the art and are solved by this invention in the manner described below.

### SUMMARY OF THE INVENTION

This invention solves the remeshing prediction problem by introducing for the first time a method for self-adaptive rezoning. The invention arises from the unexpectedly advantageous observation that linear isoparametric quadrilateral elements using selective reduced integration may be employed to predict the remeshing points based upon finite-element modeling assumptions of structural problems involving large deformations and strains. Element geometrical measures are characterized in terms of aspect ratio, taper ratio and skew angle to permit the degree of element distortion expressed in these terms to be compared to an ideal element similarly expressed. The finite-element mesh is evaluated, element by element, to quantify the geometrical relationships required to properly quantify the amount of distortion.

It is a purpose of this invention to provide a system of rezoning indicators for the automated detection of distorted elements suitable for adapting to the revision and optimization of the FE mesh.

It is another purpose of this invention to provide a self-adaptive rezoning process that employs the rezoning indicators of this invention. It is an advantage of the system of this invention that the self-adaptive rezoning process eliminates the usual limitations arising from element distortion in a Lagrangian-based mesh under large strains and deformations.

In one aspect, the invention is a machine-implemented adaptive rezoning process for implementation in a finite element (FE) analysis process for analyzing a continuum having a boundary, including the steps of (a) defining geometric and material parameters, (b) discretizing the continuum, (c) defining the element properties and geometry, (d) defining an initial mesh of nodes coupled by the elements, (e) applying boundary conditions and material parameters to the initial mesh, and (f) solving a system of simultaneous equations to find the strain displacements of a plurality of the mesh nodes as a function of a time increment, wherein the adaptive rezoning process includes the steps of (g) generating a plurality of eigenvalues responsive to the machine-implemented solution of a plurality of element eigenvalue equations, (h) generating an element distortion measure at a first mesh node responsive to the plurality of eigenvalues, (j) defining a new mesh over at least one region in the continuum responsive to the first mesh node distortion measure, (k) generating a discontinuity measure for the new mesh, (l) repeating the defining step (j) and the generating step (k) if the discontinuity measure exceeds a second predetermined threshold, and (m) mapping the initial mesh to the new mesh.

The foregoing, together with other objects, features and advantages of this invention, can be better appreciated with reference to the following specification, claims and the accompanying drawing.

### BRIEF DESCRIPTION OF THE DRAWINGS

For a more complete understanding of this invention, reference is now made to the following detailed description of the embodiments as illustrated in the accompanying drawing, in which like reference designations represent like features throughout the several views and wherein:

FIG. 1 illustrates the geometrical definition of an exemplary quadrilateral element;

FIG. 2 illustrates five exemplary quadrilateral elements exhibiting extreme values of five useful geometrical relationships;

FIG. 3 illustrates an exemplary three-dimensional (3-D) plot of strain energy density ratio varied over aspect ratio and load vector values for an axisymmetric element;

FIG. 4 illustrates an exemplary two-dimensional (2-D) plot of strain energy density ratio versus aspect ratio for an axisymmetric element;

FIG. 5 illustrates an exemplary plot of the derivative of strain energy density ratio with respect to aspect ratio versus aspect ratio for an axisymmetric element.;

FIG. 6 illustrates an example of the sensitivity of strain energy density ratio with respect to aspect ratio versus aspect ratio for an axisymmetric quad element; and

FIG. 7 is a block diagram illustrating the adaptive rezoning process of this invention.

### DESCRIPTION OF THE PREFERRED EMBODIMENT

Glossary of Terms

ABAQUS ABAQUS' Solver, a FE Analysis software product [ABAQUS, Inc, 1080 Main Street, Pawtucket, R.I. 02860-4847 USA]

adaptive meshing; iteratively regenerate mesh and solve FE problem while attempting to improve the mesh and the accuracy of the solution on each iteration

anisotropic mesh generation; uses stretched elements; desired edge length is a function of orientation; e.g. doesn't strive for equilateral triangles

element; a polygonal or polyhedral piece in the mesh; most often a triangle, quadrilateral, tetrahedron, or hexahedron (brick)

FE finite element

graded mesh generation; use elements that vary in size as a function of position mesh; an array of nodes coupled by elements

mesh generation; generate nodes and triangulate them to create a mesh in a (typically 2-D or 3-D) domain

MSC/PAL2 A FE Analysis software product [MSC Software Corporation, 2 MacArthur Place, Santa Ana, Calif. 92707 USA]

NIKE2D A FE Analysis software product [The Methods Development Group, Energy Science & Technology Software Center, Office of Scientific & Technology Information, P.O. Box 1020, Oak Ridge, Tenn. 37831 USA]

node; a vertex in the mesh

NURBS non-uniform rational b-splines

structured mesh; all elements and nodes have the same topology (i.e. same number of neighbors)

triangulation; given a set of points, connect them into a mesh of triangles

unstructured mesh; elements and nodes can have different topology; e.g. an arbitrary triangular subdivision

Introduction

The finite element (FE) methods that benefit from the rezoning method of this invention are first briefly described to assist in illustrating how the rezoning system of this invention applies to the FE methods known in the art. The issues of most interest include the element formulations and mesh reference frame most suitable for use with large deformations and strains. An understanding of the FE analysis process is useful in appreciating the purpose of rezoning required for some FE analyses. A brief overview of the FE analysis process is now described.

In applying FE analysis to a continuum, the continuum is first discretized into a series of elements that are interconnected at node points. This is done in such a fashion to properly describe the domain of the problem and to limit the infinite number of unknowns across the continuum by selecting a number of descriptive discreet points. A variety of element types exist to describe an enormous variety of problems. These problems may be found in such fields as solid mechanics, fluid dynamics, electromagnetics, acoustics and many other fields that are beginning to use the analytical power of the FE method.

Most FEs are formulated to simulate the type of behavior representative of the problem and its geometry. The mathematical formulation of the element tries to simulate the behavior of real materials under given loading conditions. The nodes and integration points serve as convenient points within the elements to obtain the values of desired variables. For solid mechanic problems, these desired variables include displacement, strain and stress.

The FE method is advantageous in that a simple solution may be found for each individual element. A summation over all the elements is then used to derive the system of equations for the entire problem. In FE analysis the element equations are formed using any of a variety of approaches loosely categorized into four general approaches; the direct, the variational, the weighted residual and the energy balance approaches. Once the system of equations are formed, by one of the these approaches, the equations are solved to produce the unknown nodal displacements. The computed discrete nodal displacement values may then be interpolated to properly describe the displacement field within each element. This process is usually achieved by using shape functions in the formulation of the element. The shape functions provide a mathematical means to interpolate between the computed node point displacements to achieve an approximation of the actual behavior of the continuum.

An important feature in the FE analysis of solid mechanics is the determination of distributed strains. Strains can be derived from the FE nodal displacement fields. This assumes that a proper measure of deformation was implemented into the equations of the analysis. The stretch ratio is one useful deformation form. The stretch ratio is defined as the ratio of the current infinitesimal gage length of a particle to its initial gage length. This can serve as an adequate strain measure by itself. Many other useful strain measures are derived from the stretch ratio. Most assume that a measure of strain is a function of the stretch ratio. The most useful stretch ratio function depends on the intended strain measure application. Because strain is a link between the kinematic and constitutive theories, a derived strain measure must be based on the ease with which the strain may be computed from the displacements and the appropriateness of the strain measure to a given constitutive law.

Nominal strain (also denominated Biot's strain) is a strain measure that is a function of the stretch ratio. The nominal strain measure is commonly used to express the FE analysis results of uniaxially-loaded test specimens and in other small-displacement, small-strain problems in the elastic region of a material under test. Logarithmic strain is a second useful strain measure commonly applied to metal plasticity problems because it closely approximates the strain measured in tension, compression and torsion tests, where “true” stress (force per current area) is measured. This is used to describe both small and large deformation and strain approximations. Finally, Green's strain is a third important and useful strain measure used in cases of large motions but small strains. The choice of strain measure must be made in view of the particular FE analysis problem and may differ for large deformations and finite strains, for large deflections and small strains or for simple small strains and small displacements.

The computed element stresses are another important consequence of FE analysis. Stresses may be determined from the strains by applying the constitutive laws for the material under test. Knowledge of material properties permits computation of a work conjugate stress measure (the product of stress and strain rate defines the work per current volume) for any given strain measure. The true (Cauchy) stress measure is one of the most useful for FE analysis because it measures the true stress at any current strain condition. The true stress measure is useful for FE models having either large or small deformations and strains.

Constitutive laws are generally derived from physical tests conducted to determine a material's behavior under various physical conditions. Many useful material models are known for approximating the behavior of a material under a variety of external conditions. Most commonly, these models describe elastic and or plastic behavior and include such parameters as yield criteria, hardening rules, flow rules, modulus of elasticity, bulk modulus and many other useful and well-known material properties. Many of these models are adapted to a rate form to provide means for modeling the strain history dependence of the material response.

The element stresses may be determined from the nodal strains by means of constitutive laws formulated on the material properties and behavior in any useful well-known manner. The FE mesh variables first provide the estimate of the kinematic strains, which are then passed to the material constitutive laws for use in computing a corresponding material-specific stress at a preselected point denominated an integration point, which one of several points within the element selected for the optimal computation of state variables such as the element stresses.

FE analysis problems are generally either static or dynamic types of problems and may be either linear or nonlinear. Most of the effort in the FE field to date was devoted to the linear static and dynamic problems and much remains to be done to improve techniques used to resolve nonlinear static, quasi-static and dynamic problems.

A FE application may become nonlinear in one of several ways. The material may exhibit nonlinear behavior as noted in the applicable plasticity models at large strains, the geometry may be nonlinear at large displacements and rotations or the loading conditions and kinematic constraints may be applied in a nonlinear fashion.

Dynamic applications predict the strain responses of the FE model over a period of time provided that the responses change sufficiently over that time period. The inertial properties tend to somewhat influence the solutions. The time rates of change also importantly affects the FE modeling process. Thus, the nature of the application generally dictates how best to formulate the FE analysis. How the FE mesh reference frame relates to a particular set of coordinates is another important factor in formulating the FE analysis. There are generally two useful methods for referencing a particular FE mesh to a coordinate system.

The “Euler” mesh permits the nodes and elements to retain coincidence with the particular spatial coordinate system, permits each element and their nodes remain fixed in space and permits the material points to migrate from one element to the next. Boundary conditions and definitions cannot be practically applied to an Euler mesh, which generally are best suited to large interior deformation problems such as fluid dynamics problems. Euler meshes are also used for problems exhibiting a significant high-frequency transient response component. The related solution equations are solved explicitly but usually require many small time steps for dynamic problems.

The “Lagrangian” mesh permits the element nodes to retain coincidence with a point in the material and permits the elements to contain the same material domain throughout the deformation process. The domain boundary is well-defined throughout the solution process in a Lagrangian mesh reference frame. The boundary is always described by the odes and elements and therefore boundary motion causes no problems. Lagrangian meshes, solved implicitly, allows the use of larger time steps in dynamic problems and larger increments in static or quasi static problems. Implicit FE codes are generally used for metal forming processes and structural analysis and design problems involving static, quasi-static and dynamic problems with a significant low-frequency response component. The time increments required with Lagrangian meshes may be up to three orders of magnitude greater than those required for Euler meshes.

Lagrangian meshes are disadvantageous with large element distortions such as may occur during FE modeling of plastic flow under heavy load, for example. The element distortions may result in inaccuracies and ill-conditioned FE solutions. One solution to this problem is to rezone the mesh at some point during the analysis to eliminate element distortions. Rezoning as used herein means the creation of a new acceptable mesh in all regions exhibiting poor element behavior arising from element distortion and includes the remapping of the earlier mesh variables into the new mesh variables. The rezoning process depends upon many of the usual factors mentioned above in connection with the FE formulation process. The key feature of the self-adaptive rezoner of this invention is to overcome the FE analysis difficulties arising from element distortions from large deformations and strains in Lagrangian-based FE meshes.

The Adaptive Rezoning Procedure

The self-adaptive rezoning method of this invention is now described. The theoretical basis for the method is discussed and exemplary embodiments of self-adaptive rezoning systems are described. A general rezoning technique adapted to the system of this invention is discussed.

The rezoning indicators of this invention are first discussed. These rezoning indicators permit the automatic detection of distorted elements and provide information required to create and optimize the new mesh. The self-adaptive rezoning method of this invention is next described. This method uses the rezoning indicators determined in the first step to overcome the limitations arising from the Lagrangian-based mesh elements distorted by large strains and deformations.

The need for self adaptive rezoning stems from the use of Lagrangian based FE methods and the desire for automation of the process. In FE solutions that use Lagrangian meshes for large deformation problems, the solution process tends to loose accuracy as the elements become distorted. This causes failure in convergence and inaccurate results in the implicit calculations and solution. Rezoning has been an answer to these problems. In many applications, especially those related to metal-forming (implicit) and shock-wave propagation in complex structures (explicit), the need to rezone the mesh becomes unavoidable. Because of the nature of some of these applications, the use of better elements or solution procedures does not alleviate the need to rezone because of the amount of distortion in the elements. Rezoning should always be used for those applications where any part of the mesh becomes grossly distorted during the solution process.

In the art, there are many suggestions and little theory on how best to use error estimates to examine and improve the results and accuracy of a FE solution. Most of the work on improvement of mesh accuracies refers to the self-adaptive error analysis and improvement techniques denominated a posteriori error estimation. This method is most useful with static cases and has been theoretically validated for the one-dimensional cases. No theoretical basis exists for applying a posteriori error estimation to higher order linear problems or to nonlinear problems. This technique is useful for optimizing the FE mesh for linear static problems to minimize the inaccuracies caused by the mesh. An iterative technique is required to converge on an appropriately accurate solution via mesh refinement.

A posteriori error estimators are generally most useful with either the h-type or p-type mesh refinement techniques to improve upon the FE mesh. The h-type of mesh refinement involves the subdivision of the element domain into more and smaller elements. The p-type mesh refinement involves increasing the order of the element. Both techniques are effective in improving the FE mesh for better solution accuracy. Combinations of the two mesh refinement techniques are also useful.

The a posteriori error estimation procedure for static linear cases is initiated by solving on an initial mesh. After the solution process ends, an error is estimated by any one of a variety of useful means, such as by the method of residuals, for example. The error estimate is then accepted as a measure of the “goodness” of the mesh. The h and/or p-type refinement process is next applied to refine the mesh by the amount indicated by the error estimate. The FE solution is obtained again on the improved mesh. This process iterates until attaining a convergence limit of some sort; this is an iterative optimization technique.

The adaptive mesh rezoning process uses the typical a posteriori error estimation technique, with some differences. First, rezoning is used in large deformation and quasi-static or dynamic type problems. Second, the initial mesh is assumed appropriate and the iteration process is used to correct the mesh errors arising from grossly distorted elements. During each mesh correction cycle, an optimum mesh is attempted for the newly rezoned region to reduce any future rezoning. Because the rezoning techniques known in the art are not self-adaptive, human intervention is required to select remeshing parameters. There are no useful indicators for automating the timing and character of the rezoning step. The user of a FE analysis system with a rezoning procedure must halt the FE solution, decide if a rezoning is required, and direct the system where and how the mesh must be rezoned. Such a user is obliged to have a good understanding of the elements used, the nature of the problem and when elements are distorted beyond use.

The first step in the adaptive rezoning process is to be able to determine the geometry of each of the FEs in the mesh and provide some type of measures that define the current geometrical shape of each element. These measures act as comparative criteria against some distortion indicators to determine if an element has undergone an excessive amount of distortion. An element's current geometrical configuration is compared to that of an ideally shaped element. This process provides a mechanism to examine the geometry of the mesh and to define geometrical measures for identifying those elements that have been distorted beyond use.

The indicators for when and where the rezoning process occurs are closely related to the solution variables in the FE solution process. For example, the amplitude and gradient of strain, stress, displacement or strain energy density may be suitable. Locating mesh regions of extreme values or rates of change or areas of high gradient values near or at distorted elements may identify a need to rezone in these regions. The rate form of quantities, such as strain rate, are also of interest as rezoning indicators. Strain rate versus a quantity such as the plasticity index may provide an indication of when the solution has exceeded the strain rate capacity of the material.

In the system of this invention, the a posteriori error estimators are used in a self-adaptive manner to reform the same mesh to arrive at an optimized mesh layout. This process proceeds automatically without user input. This is a key element. The few rezoners that exist in the art rely heavily on user input to perform this task.

The determination of the regions to be rezoned is in general not too much of a problem given some appropriate rezoning indicators and following the procedure previously described. Usually the rezoning is restricted to a local region of the mesh. The actual rezoning must extend out past the elements that were flagged for rezoning and those deemed near or approaching the distortion limit criteria. According to Saint Venant's principle, the effect of a distorted element to the surrounding elements diminishes rapidly with distance from that element. Thus, if the distorted element is in a region of little interest, there is little incentive to fix it because its effect is localized. For rezoning purposes, the amount of the mesh away from the distorted elements and those elements that are near or approaching distortion, that must be included in the region to be rezoned is a topic of debate. A minimum good rule of thumb in the remeshing process is to include at least those elements that surround the distorted elements and those near or approaching distortion.

Once it has been determined that rezoning is required and the region for rezoning has been flagged, then that region must be remeshed. The nodes and elements of the new mesh must be of an acceptable nature. Rezoning is of no benefit if the newly created mesh is no better off than the previous mesh. Furthermore, remeshing is needed to the extent that no additional remeshing of the region remains valid for some minimum number of time increments. This implies that the new mesh or remesh is to be optimized in some fashion in accordance with the pattern of the future distortions in the mesh as well as those elements flagged by the rezoning indicators. The boundaries of the mesh must also remain the same. The remeshing may either reshape the existing elements to a more acceptable element shape, or refine the mesh in the given area with acceptable smaller elements. A combination of these two is most likely.

Once the new mesh is created, the element variables from the old mesh must be mapped over to the new mesh. The manner in which this procedure is performed is important. If the rezoning process and indicators are precise in determining when and how rezoning should take place and the remeshing part of rezoning is optimal, yet the remapping of the element variables is shoddy or erroneous, the effort is wasted. Most remapping techniques use some type of interpolation or weighted parameters based on the positions of the old mesh to that of the new mesh. It should be noted that the old mesh means the mesh prior to the solution that was flagged for rezoning.

Once the rezoning process is complete the element variables are checked for discontinuities. If discontinuities in the variables are present and of sufficient size, then this serves as a final rezoning check. Under such conditions, rezoning either occurred too late in the process or the mesh during the rezoning was not sufficiently refined. The remapping of the variables may also have been incorrect. If this is encountered, the rezoning process may be repeated or even stepped back. Another option is to decrease the time increment size. If the discontinuities are relatively small then the solution may proceed until the next rezoning process is flagged.

The adaptive rezoning process may be implemented into FE codes in various ways. The adaptive rezoning process may be focused to be applicable to certain types of applications under certain conditions and assumptions. An approach based upon a given set of conditions and assumptions is discussed. These conditions and assumptions help to narrow the applications of rezoning to those of interest.

Nonlinear quasi static and dynamic problems of large deformations, large strains and for some problems high strain rates are the applications that most require the rezoning process. Specifically, such problems entail impacts at high velocities, metal forming processes and large deformation problems in general. A large variety of such problems may be modeled using two-dimensional (2-D) elements. This process, however, may easily be extended to other types of elements and three-dimensional (3-D) cases.

The applications of interest are either dynamic or quasi static. In general they are always nonlinear. For such problems, a direct integration technique is used in the solution process. A standard implicit time integration operator is used that is a slight modification of the trapezoidal rule called the Hilber-Hughes-Taylor operator. This implicit time operator solves the nonlinear dynamic equilibrium equations at each time step and does so iteratively by Newton's method. An automatic time incrementation scheme is used that adjusts the time increment after such events as a sudden impact. This of course, assumes the use of a Lagrangian-based mesh. This solution technique is used in ABAQUS' Solver, which is a commercially-available software product [ABAQUS, Inc, 1080 Main Street, Pawtucket, R.I. 02860-4847 USA].

ABAQUS is an implicit Lagrangian FE code suited for all of the conditions and assumptions such as proper material models, as well as finite strain and large deformation capabilities. ABAQUS is allows the eigenvalue testing of elements with only a simple manipulation of the mass matrices. This allows the use of the code to obtain the required data to derive the rezoning indicators. ABAQUS also allows the solution process to be stopped and restarted again at a desired time increment, allowing integration of the rezoning process of this invention. ABAQUS includes a rezoning procedure but it is strictly limited to a user-specified procedure. Various output procedures allow access to the element and nodal data bases for changes to be made during rezoning.

Most metals are considered to behave in a ductile fashion and exhibit relatively small amounts of elastic deformation in comparison to the amount of plastic or inelastic deformation that they can achieve before failure. This behavior may be approximated or modeled by the elastic-plastic models common to many FE codes. FE models of elastic and inelastic behavior of metals are therefore considered to be valid assumptions for adaptive rezoning. The inelastic response is simulated with a plasticity model. In plasticity theory the elasticity part of the model is not effected by the inelastic deformation. The elasticity theory assumed is the one standard to most text books.

The logarithmic strain measure is useful because it is the measure commonly used in metal plasticity problems and is appropriate for cases where the elastic part of the strain in a elastic-plastic analyses may be assumed to be very small. Many structural metals typically have an elastic modulus two to three orders of magnitude larger than the yield stress and thus exhibit relatively small elastic deflections. This permits separation of the inelastic and elastic responses into recoverable (elastic) and nonrecoverable (inelastic) parts. The classical strain rate decomposition of plasticity theory is used, which assumes an additive relationship between the strain rates. The rate of deformation is used as the strain rate measure. Total strain is defined as the integral of the rate of deformation in large displacement analysis. This class of problems therefore is based on finite strain formulation.

The inelastic (plastic) response is assumed to be fully incompressible in metals undergoing large plastic flow. When the material is flowing plastically, the inelastic part of the deformation is defined by a flow rule. A single flow potential is assumed. The plasticity model uses isotropic hardening. Increases in strain rates typically cause an increase in the yield stress of the material. This is modeled because high strain rates are typical for the class of problems being considered. Metal plasticity models use the Mises stress potential for isotropic metal behavior. They depend only on the deviatoric stress so that the plastic part of the response is incompressible. In addition to the element displacement, the true or Cauchy stress and logarithmic strain for each element are sought.

Two-dimensional first-order isoparametric quadrilateral elements using selective reduced integration are preferred. These elements are either plane strain, plane stress, or axisymmetric elements. The elements are first order or linear in interpolation with only four nodes, one at each of the comers. This type of element has been chosen for the applications of interest, that being large deformations and strains leading to an incompressible material response. Note that the choice of elements could be extended to higher order elements without too much difficulty. The sides of the elements are assumed to remain straight. A lump mass versus consistent mass matrix is used in the FE models. Using lumped mass is generally easier and more appropriate with dynamic problems. The elements are formulated for finite strains and large displacements. FE distortion is most likely element type sensitive, therefore restrictions on the choice of element type aids in focusing the study on rezoning.

In problems where plastic flow ends up dominating the response and the material behavior is near or fully incompressible, as seen in such cases as metal forming problems. The element choice and the integration scheme of the element's stiffness matrix is important. The elements must accommodate the incompressible flow assumption in the plasticity theory. Usually for these cases reduced integration elements are used. Occasionally hybrid type elements may be used. Reduced integration, however, may lead to singular or hourglass modes. These modes may grow in an unbounded fashion if uncontrolled. Singular or hourglass modes cause irregularities and ill-conditioning in the solution process. Fully integrated first-order continuum elements, however, may be used with selective reduced integration, where just the volumetric strain is calculated at the centroid {reduced integration point) of the element instead at other integration points. In selective reduced integration, the order of integration is reduced for selected terms in the fully integrated element, like the volumetric strain, for example. This helps to prevent the mesh-locking that otherwise occurs in fully integrated elements when the response is incompressible. The volumetric strain is then extrapolated to the four integration points in the two-by-two Gauss quadrature integration scheme. First-order elements with selected reduced integration are therefore suitable for the applications of interest

Given the need for adaptive rezoning of FE meshes and provided with a specific class of problems, the most effective approach to the rezoning method for large deformation FE problems is now discussed.

First, the FE mesh is inspected for distorted elements. The geometrical measures of quadrilateral element shapes may be classified as aspect ratio, taper ratio, skew angle, triangular quadrilaterals and inverted elements. These geometrical values must be examined for each element at each step in the solution, as discussed below in more detail.

Next, each element is tested against a rezoning indicator to determine whether the element is distorted or approaching distortion. The rezoning indicators are defined in terms of the measures used in defining the element geometry. The rezoning indicators thus are comparable with the geometrical measures and may be derived by means of, for example, eigenvalue testing as discussed in detail below. Examination of large values of displacement, strain, stress and strain energy density, or steep gradients of these values, in the region of a distorted element permits confirmation of the rezoning indicators derived from eigenvalue tests. The rezoning indicators derived from eigenvalue tests are formulated by comparing ratios of strain energy density of distorted element shapes to an ideally-shaped element under controlled conditions. The formulation of the strain energy density values is based on the eigenvectors and eigenvalues derived from an eigenvalue test of the element's stiffness matrix. This procedure is described more specifically below.

The rezoning indicators act as the focal point in a self-adaptive rezoning process. The element distortion limits established by the rezoning indicators permit the flagging of distorted elements and identification of which elements attain distortion during future time increments. This information is used in the remeshing phase of the rezoning process of this invention.

Next, a new FE mesh is generated based on the information obtained from examining the geometrical relationships of the old mesh to the rezoning indicators. The new mesh formulation is based on the previous, present and future deformation patterns exhibited by the FE mesh. The knowledge of which elements are being distorted throughout the solution process, as well as the pattern and type of distortion, allows reshaping of the mesh to anticipate and correct for the distortions. With the insight provided by the rezoning indicators as to when the distortions occur throughout the process, a new mesh at a given increment or time step may be optimized to reduce the number of future rezonings.

Caution is required to avoid losing valuable information obtained in the remeshing procedure. For example, an area of refined element size should remain refined during the remeshing if the refined region was put there to achieve more accuracy in the solution, such as stress concentration points. Such a technique is difficult to incorporate into an self-adaptive rezoning procedure. Expert systems are required to effectively achieve this task. In addition, initial user input is required to define the desired parameters of the problem. In the system of this invention, interactive user input is used to achieve the desired remeshings of the rezoning process. The remeshing, however, is based on the automated application of use of the rezoning indicator procedure with the aid of various existing mapping techniques as described herein.

The final step is to remap the element variables of the old mesh onto the newly created mesh. This is preferably accomplished by means of an interpolation scheme. The ABAQUS FE Analyzer or any other useful means may be used to perform the remapping process. The ABAQUS FE Analyzer includes an automatic remapping procedure, which allows an efficient remapping of all the solution variables. The remapping itself may also serve as a rezoning indicator.

This entire process is repeated at each point during the FE solution process where the rezoning indicators flag elements of the mesh for rezoning. Optimizing each step of the process reduces the total number of rezonings required. This is important because each rezoning adds additional computational load to the solution process. There are many FE codes that are adequate as a FE solver that may not only solve large deformation problems, but may also be used to implement an adaptive rezoning procedure, including, for example, ABAQUS and NIKE2D [The Methods Development Group, Energy Science & Technology Software Center, Office of Scientific & Technology Information, P.O. Box 1020, Oak Ridge, Tenn. 37831 USA].

NIKE2D is an implicit finite deformation, large strain FE analyzer for static, quasi-static and dynamic analysis of 2-D structural calculation problems. Plane stress, plane strain and axisymmetric problems can be solved. NIKE2D has a built in interactive rezoning process. ABAQUS' rezoning process has a built-in interpolation scheme designed to remap the nodal and element variables from the old mesh to the new mesh.

Integration of the ABAQUS analyzer with the self-adaptive rezoning procedure of this invention is not permissible so when using ABAQUS, some user intervention is still required to perform the “self adaptive” rezoning process. This limitation does not exist for implementations of this invention including direct combinations of the rezoning method of this invention with the FE Analyzer processes exemplified by the ABAQUS analyzer.

The Element Distortion Measure

An integral part of the self-adaptive rezoner is the means to examine the FE mesh at each time increment to test for the presence of any distorted elements. The method of this invention for characterizing an element's geometry in terms of aspect ratio, taper ratio and skew angle is described and contrasted to a distortion measure. An ideal element shape is used as a reference.

The first requirement for a FE rezoner is an procedure that examines the FE mesh at each time increment. This procedure determines all required geometrical relationships within each element of the mesh. For quadrilateral elements, these include aspect ratio, taper ratio, skew angle, triangular quadrilaterals and inverted quadrilaterals. Triangular and inverted quadrilaterals may be classified as subsets of the skew angle. The discussion here is limited to quadrilateral elements, however, it could as easily apply to other type of elements such as the 3-D brick elements. The geometrical measures are compared to the same type of measures for an idealized element. An idealized element is defined as an element that provides an optimum value for each of the geometrical measures of its shape.

The geometry inspection of the elements of the mesh is an essential key in the rezoning process. All rezoning indicators eventually relate back to the geometry of the elements and all changes to the mesh are related to the physical geometry of the mesh. A robust method of element geometry inspection is therefore required.

The use of quadrilateral elements in FE models and in the rezoning process is used as a basis for the following exemplary description. The geometry inspection procedure for other types of elements is similar. Many applications of large deformation FE codes that require rezoning are modeled with quadrilateral elements such as plane strain, plane stress and axisymmetric elements.

Each element is isoparametric and limited to four nodes. Each element uses first order or linear interpolation. Lumped mass is assumed. This classification of elements greatly simplifies the description of an adaptive rezoner. Procedures used to examine the geometry of 2-D first-order isoparametric four-node quadrilateral elements may be extended to other types and orders of elements.

Elements perform best if their shape is compact and regular. Elements tend to loose accuracy as the aspect ratio increases, the comer angles become markedly different from one another, sides become curved, and if side nodes exist, when their positions become unequally spaced. Ideally, a quadrilateral element has an aspect ratio near unity, the comer angles near ninety (90) degrees, the side nodes (if they are used) at the element mid sides, straight sides or edges and no great size differences between adjacent elements. The ideally-shaped element is square in shape, of unit dimension along each edge, corner angles at ninety (90) degrees and lumped mass at the nodes. A rectangular element under constant strain conditions can perform just as well as a square element. Close attention should be given when such cases arise.

The geometrical relationships of a given quadrilateral element must be defined as a basis for the possible geometrical distortions of a quadrilateral element. FIG. 1 illustrates the geometrical definition of an exemplary quadrilateral element 20. The first step is the numeration of the nodes, exemplified by the node 22, and their corresponding ordering. Each element has four nodes identified by numbers such as 1, 2, 3 and 4. Each node point 22 includes a unique node number and an x and y coordinate value. The numbering is preferably sequential from some starting node and marching around the element in counter-clockwise fashion as seen for element 20. The first node may be arbitrarily selected from so long as the nodes are sequentially ordered in a counter-clockwise fashion. The next step is the labeling of the element edges, exemplified by the edge 24, each of which are also directed as exemplified by the direction indication 26. In FIG. 1, the edges are labeled as A, B, C and D. Edge A lies between the first and second nodes and is directed from node 1 to node 2. The other edges follow similarly in counter-clockwise sequence around element 20. Finally, the element angles, exemplified by the angle 28, are defined as the interior angles of element 20. The first angle φ₁ is defined by the edges D and A, the second angle φ₂ by edges A and B and so forth. Each angle is defined by the intersecting edges at a corresponding node point. The ordered nodes with coordinate points, the directed element edges and the interior angles are sufficient to define the geometry of any 2-D first-order four node quadrilateral element such as element 20.

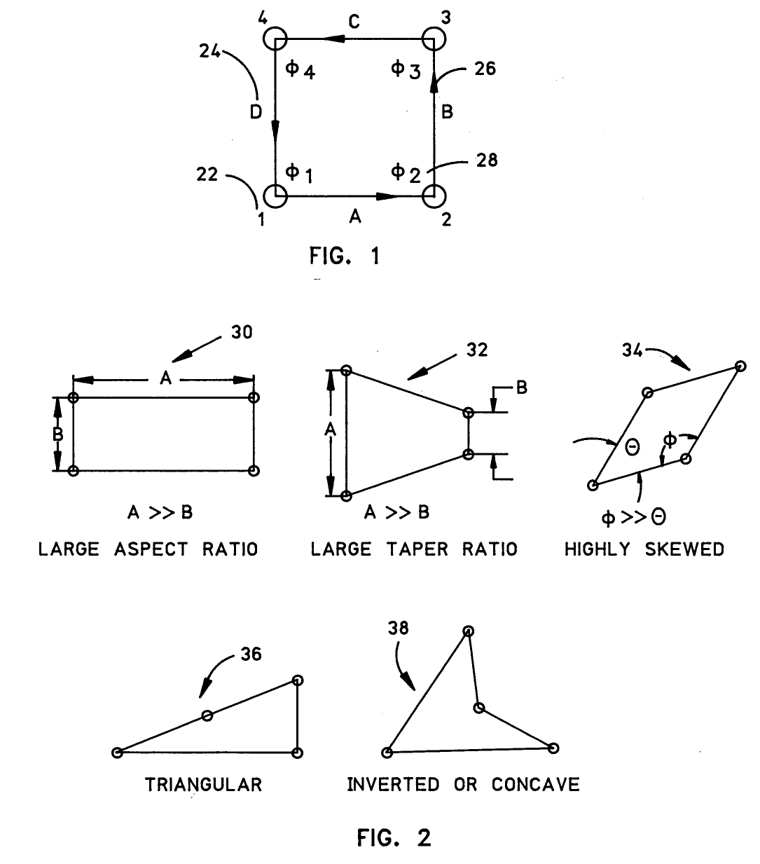

FIG. 2 illustrates five important geometrical relationships that are useful for defining the geometric character of a quadrilateral element. These are (a) aspect ratio, (b) taper ratio, (c) skew angle, (d) triangular quadrilaterals and (e) inverted quadrilaterals. Exemplary quadrilateral elements having extreme examples of these values are depicted in FIG. 2.

Aspect ratio is defined as the ratio of the length of a given edge to the length of an adjacent edge. This makes possible four different aspect ratios. Note that their inverses would actually create four more possibilities but only four are required to uniquely define the possible aspect ratio combinations. In FIG. 2, the element 30 has a large aspect ratio.

Taper ratio is defined as the ratio of the length of a given edge to the length of an opposite edge, not the adjacent edge. This makes possible two different taper ratios. Note that their inverses would actually create two more possibilities but only two are required to uniquely define the possible taper ratios. In FIG. 2, the element 32 has a large taper ratio.

Skew angle is defined as the value of the interior angle given by two adjacent edges at a given node. There are only four unique angles. Note that ratios of the angles are available but the angles themselves are sufficient in defining the skew of an element. In FIG. 2, the element 34 has a large skew angle.

Quadrilateral triangles are formed when three of the four nodes collinear, forcing one of the element interior angles to one-hundred-and-eighty (180) degrees. Generally such a situation is rarely used in rezoning because the angles given in the skew relationship detect and initiate a fix before any interior angle approaches anything close to one-hundred-and-eighty (180) degrees. Quadrilateral triangles are a special case of a high skew angle measure. In FIG. 2, the element 36 is a quadrilateral triangle

An inverted quadrilateral has a portion of the element turned inside out or concave, forcing one of the interior angles to exceed one-hundred-and-eighty (180) degrees. This indicates extreme element distortion that complicates the FE solution process. Inverted elements are also a special case of a high skew angle measure. In FIG. 2, the element 38 is an inverted (concave) element.

The aspect ratio of a quadrilateral element is first determined by finding the length of each of the edges. Because first order quadrilateral elements have straight sides, the distance between the beginning node and ending node of each edge is alone sufficient. The x and y coordinates of each node point and hence the ends of each edge are known. Once the lengths are obtained, the maximum ratio of adjacent edge lengths is computed. This indicates the largest aspect ratio for the element which in turn is compared to an ideally shaped element and eventually to a rezoning indicator.

The taper ratio of a quadrilateral element is determined in similar fashion to that of the aspect ratio. The only difference between determining the taper ratio value and that of aspect ratio is that taper ratio uses the ratio of opposite edge lengths instead of adjacent edge lengths.

The skew angle of an element is determined by using the dot product formula. The interior angle to be determined is first selected. Next, the two intersecting edges that form the angle are selected as the vectors to use in the dot product formula. The direction of the first vector (edge) is reversed because of the definition of the direction of the edges. The magnitudes of the lengths of the vectors and each of their x and y components is then determined and used in the dot product formula. This equation may then be manipulated to solve for the value of the angle. The same element geometrical configuration of FIG. 1 depicts the geometry used to obtain the skew angle given in Eqn 2. The dot product is defined by Eqn. 1,

\vec{D}·\vec{A}=|\vec{D}||\vec{A}|cos φ₁ [Eqn. 1]

which is solved for the angle φ₁ to obtain Eqn. 2.

$${φ}_{1} = {cos}^{- 1} \frac{\vert {D}_{x} \vert \vert {A}_{x} \vert + \vert {D}_{y} \vert \vert {A}_{y} \vert}{\vert \vec{D} \vert \vert \vec{A} \vert} \qquad [ Eqn . 2 ]$$

where the angle φ₁ is defined by element edges D and A (FIG. 1).

The determination of a triangular quadrilateral is accomplished by searching either for three consecutive nodes along a straight line or any two adjacent edges of the same slope. Another method is to use the skew angle equations to check for any interior angle that equals one-hundred-and-eighty (180) degrees.

Inverted or concaved quadrilateral elements may be identified by using a cross product formulation. This procedure is similar to the skew angle procedure. The vector direction of the first of two adjacent edges is reversed and the cross product formulation used. A negative result from the z-component defines a concave element. If the value is positive, the element is neither concave nor turned inside out. This process is repeated for all four edge combinations until any one or none of the combinations indicate an inverted element. The geometry for Eqns. 3 and 4 is depicted in FIG. 1. The cross product in vector component form, which has a z-component out of the element plane is given by Eqn. 3.

i \vec{D}×\vec{A}=(D_{y}A_{z}−D_{z}A_{y})î+(D_{z}Aₓ−DₓA_{z})ĵ+(DₓA_{y}−D_{y}Aₓ)\hat{k} [Eqn. 3]

Solving for the sign of the z-component gives Eqn. 4,

INVERT=SIGN(D_{X}A_{y}−D_{y}A_{X})\hat{k} [Eqn. 4]

where a negative sign indicates an inverted element.

Warping is not considered. It is assumed that all quadrilateral elements remain planar. By observation triangular and inverted quadrilaterals are definitely defined as distorted elements.

The Element Distortion Threshold

The prior art provides some suggestion of the permissible quantitative element distortion before encountering unacceptable solution inaccuracies. Aspect ratio distortion limit values range from fifteen to twenty. Skew angles values below thirty (30), forty-five (45), or fifty (50) degrees and above one-hundred-and-thirty (130) or one-hundred-and-fifty (150) degrees are deemed as distorted (requiring remeshing). Taper ratio values that exceed a two (2.0) are deemed to be distorted elements. Some practitioners in the art suggest that any edge length less than one-tenth of the average edge length creates FE solution inaccuracies. These quantitative limits in the art stem from experience and intuition and are used in mesh checking procedures throughout the art.

In creating the self-adaptive rezoning system of this invention, the inventor reevaluated these limit values, both theoretically and experimentally. As expected, the geometrical distortion factors developed for the system of this invention correlate to some degree with the rule-of-thumb values obtained by experience and intuition in the art.

The inventor devised a computer program to inspect the geometry of each element in a FE mesh. Each element of the mesh may be systematically examined to ascertain the maximum values of aspect ratio, minimum and maximum values of skew angles, minimum values of taper ratios, the inversion of an element and coincident nodal points of each of the elements. These values may then be compared to rezoning indicators and stored for use in the remeshing process. When the comparison with the corresponding rezoning indicator detects variation (depending on the criteria), the element is flagged as distorted.

A necessary and very important part of a self adaptive rezoner is the means to determine when an element is distorted to the point that the errors in the solution tend to grow more rapidly and cause havoc with the solution process. Rezoning indicators are the geometrical measures of an element that determine when an element is too distorted for use and rezoning must take place.

A key element of a self-adaptive rezoner is the automatic identification of the point in the solution process at which and manner in which the FE mesh must be rezoned. Eigenvalue testing of FEs is used to derive parameters suitable for use as mesh rezoning indicators and measures of mesh correction. Eigenvalue tests are tests of element quality. Eigenvalue testing is generally used to detect zero-energy deformation modes, lack of invariance and absence of rigid-body motion capability. Eigenvalue tests are also a useful means to estimate the relative quality between different elements. In essence, the eigenvalue test solves an eigenvalue problem that is formulated solely on the FE stiffness matrix. The solution yields eigenvalues and eigenvectors that may be related to the strain energy associated with the element. The eigenvectors are also associated with the possible deformation modes and rigid body modes of the element. Thus, the eigenvalue test provides a good indication of how an element should deform and provides terms to generate a measure of the energy associated with that deformation.

Rezoning indicators are determined by using the results of eigenvalue tests on elements of a given distortion and comparing them against eigenvalue test results on an ideal element. The eigenvalue test results are incorporated into an equation to derive the strain energy density. Doing this over a range of distortion values for the various distortion parameters of aspect ratio, taper ratio and skew angle, identifies when the element deformation pattern and associated strain energy density begin to cause FE solution errors.

The methodology that is used to derive the distortion indicators from the results of an eigenvalue test is known in the art. See, for example, Rigby et al., [G. L. Rigby and G. M. McNeice, “A Strain Energy Basis for Studies of Element Stiffness Matrices,” AIAA Journal, 10 1490-1493, 1972] for a discussion of a strain energy basis for the study of element stiffness matrices. Rigby et al. provide an equation relating the eigenvectors and eigenvalues from an eigenvalue test, along with an assumed load vector, to the strain energy capacity of the element.

The inventor extended the Rigby et al., principle to handle the effects and behavior of geometrical distortions in the elements, thereby for the first time providing rezoning indicators from eigenvalue tests suitable for the automated remeshing process of this invention.

Rezoning indicators that are derived from results of eigenvalue tests can be shown mathematically to be directly related to the parameters upon which the deformation characteristics and strain energy content of a quadrilateral element are based. This in turn leads to the formulation of an equation that is based upon the deformation characteristics and generates the strain energy of a given element assuming a given load vector. Assuming that the displacement model of the FE is based on the minimum potential energy principle, then

[k]{d}={r} [Eqn. 5]

This is the basic FE equation that relates the element stiffness matrix [k] and displacement vector {d} to a load vector {r}. The assumption is made that the load vector is proportional to the displacement vector through a factor X and Eqn. 5 becomes

[k]{d}={r}=λ{d} [Eqn. 6]

Rearranging the terms of Eqn. 6 gives

([k]−λ[I]){d}={0} [Eqn. 7]

which is an eigenvalue problem where λᵢ is an eigenvalue of the stiffness matrix [k]. Each λᵢ has a corresponding eigenvector {φ}ᵢ where

$${\{ φ \}}_{i}^{T} {\{ φ \}}_{j} = \{ \begin{matrix}1 & if & i = j \\ 0 & if & i \neq j\end{matrix} \} \qquad [ Eqn . 8 ]$$

defines how the eigenvectors are normalized. Multiplying each side of Eqn. 7 by {φ}ᵢ^{T} and examining the equation for each node gives

{d}ᵢ^{T}[k]{d}ᵢ=λᵢ [Eqn. 9]

Recalling that strain energy is defined by

U=½{D}^{T}[K]{D} [Eqn. 10]

a parallel is drawn between Eqns. 10 and 9. Eqn. 9 implies that the eigenvalue of a given mode λᵢ is equivalent to twice the strain energy for that mode with the normalized displacements or eigenvectors being used, thus

2Uᵢ=λᵢ [Eqn. 11]

Eqn. 11 clearly states that the eigenvalues derived from an eigenvalue test of an element's stiffness matrix [k] are directly related to the strain energy of the element associated with the deformation pattern of a given mode. A summation of all the eigenvalues divided by two would then determine the entire strain energy for a given displacement. The derivation of strain energy may be taken one step further to not only incorporate the eigenvalues but the eigenvectors as well. The displacement vector of Eqn. 5 is equated to the summation of each eigenvector times an assumed coefficient such that

$$\{ D \} = {\sum }_{i = 1}^{n} {c}_{i} {\{ φ \}}_{i} \qquad [ Eqn . 12 ]$$

where n in the summation is the number of degrees of freedom in the element minus the number of rigid body modes of the element. Eqn. 12 substituted into Eqn. 10 and using the relationship of Eqn. 9 yields

$$U = \frac{1}{2} {\sum }_{i = 1}^{n} {c}_{i} {λ}_{i} {c}_{i} \qquad [ Eqn . 13 ]$$

Using Eqns. 5, 12 and 9, the coefficient Cᵢ may be determined along with premultiplying Eqn. 5 by each eigenvector. The coefficient is given by

$${c}_{i} = \frac{{\{ φ \}}_{i}^{T} \{ r \}}{{λ}_{i}} \qquad [ Eqn . 14 ]$$

Substitution of Eqn. 14 into the strain energy relationship of Eqn.13 causes the strain energy equation to become

$$U = \frac{1}{2} {\sum }_{i = 1}^{n} \frac{{( {\{ φ \}}_{i}^{T} \{ r \} )}^{2}}{{λ}_{i}} \qquad [ Eqn . 15 ]$$

It is clear from this derivation that Eqn. 15 formulates the strain energy content of an element based on the eigenvectors and eigenvalues generated from an eigenvalue test of the element's stiffness matrix. The load vector used in the equation is the load vector that creates the deformation pattern characterized by the eigenvectors and therefore generates strain energy within the element characterized by both the eigenvectors and eigenvalues.

Eqn. 15 is used in a comparative ratio to finally arrive at an equation that may be used to quantify distortion or rezoning indicators. The ratio is the strain energy of an ideal element to that of a distorted element given by

$$\overline{U} = \frac{Ideal Strain Energy}{Distorted Strain Energy} = \frac{{\sum }_{i = 1}^{n} \frac{{( {\{ φ \}}_{i} \{ r \} )}^{2}}{{λ}_{i}}}{{\sum }_{k = 1}^{n} \frac{{( {\{ ψ \}}_{k} \{ r \} )}^{2}}{{η}_{k}}} \qquad [ Eqn . 16 ]$$

Calculating values generated from Eqn. 16 over a range of the specified distortion parameters of aspect ratio, taper ratio and skew angle creates sets of data that may be examined for discontinuities in the change of the strain energy ratio values as compared to the changes in given distortion parameter values.

It is also of interest to mathematically examine the structure of a quadrilateral element stiffness matrix. This reveals how the geometry of the element is embedded in the equations that form the stiffness matrix. These geometrical terms may then be related to the specific distortion parameters of aspect ratio, taper ratio and skew angle. This illustrates how a change in the shape of the element can affect the performance of the element.

The standard FE equation for the stiffness matrix is

$$[ k ] = {\int }_{V}^{} {[ B ]}^{T} [ E ] [ B ] ⅆ V \qquad [ Eqn .17 ]$$

where [B] is the strain-displacement matrix and [E] is the material matrix. The equation is integrated over the volume of the element. A plane strain isoparametric element is examined. The results for plane stress and axisymmetric isoparametric elements would only differ slightly, thus the plane strain case is representative of the other types of elements described herein. For a plane strain isoparametric element Eqn. 17 is

$$[ k ] = \int \int {[ B ]}^{T} [ E ] [ B ] t ⅆ x ⅆ y \\ = {\int }_{- 1}^{1} {\int }_{- 1}^{1} {[ B ]}^{T} [ E ] [ B ] t J ⅆ ζ ⅆ η \qquad [ Eqn .18 ]$$

where t is the thickness of the element, for this case t is set equal to one and J is the determinant of the Jacobian matrix. These quantities are required for the transformation of x and y coordinates to the isoparametric ζ and η coordinates.

The geometry of the element is embedded in the strain-displacement matrix [B] and also the determinant of the Jacobian matrix J. The geometry of a four node quadrilateral element may be defined by just the x and y nodal locations. For isoparametric elements, a coordinate transformation from the x and y coordinates to isoparametric coordinates ζ and η is given by

$$x = {\sum }_{i = 1}^{4} {N}_{i} {x}_{i} , y = {\sum }_{i = 1}^{4} {N}_{i} {y}_{i} \qquad [ Eqn .19 ]$$

where Nₜ represents a shape function. The four shape functions used in the element formulation are

$$\begin{matrix}{N}_{1} = \frac{1}{4} ( 1 - ζ ) ( 1 - η ) & [ Eqn . 20 a ] \\ {N}_{2} = \frac{1}{4} ( 1 + ζ ) ( 1 - η ) & [ Eqn . 20 b ] \\ {N}_{3} = \frac{1}{4} ( 1 + ζ ) ( 1 + η ) & [ Eqn . 20 c ] \\ {N}_{4} = \frac{1}{4} ( 1 - ζ ) ( 1 + η ) & [ Eqn . 20 d ]\end{matrix}$$

These relationships bind the two coordinate systems together. If a relationship can be defined that correlates the x and y coordinate points of an element to the distortion measures of aspect ratio, taper ratio and skew angle, it may then be transformed into the isoparametric coordinates using Eqns. 20a-d. The shape functions, Eqn. 20a-d, and their derivatives are used extensively in the formulation of the strain-displacement matrix and the determinant of the Jacobian matrix. The relationship to the geometrical parameters that describe the shape of the element are therefore an integral part of the stiffness matrix.

Relationships between the x and y coordinates of the element and the distortion measures of aspect ratio, taper ratio and skew angle may now be determined. The length of each of the edges as well as the lengths of the two diagonals formed from opposite nodes are easily determined from the nodal coordinate points. Two area equations may also be formulated. The first area equation is based on solving the area of the two triangles formed by the first diagonal. Simple geometrical relationships make this possible. The second area equation is identical, the only difference being the second diagonal and the two resulting triangles that are used to determine the area.

The edge lengths, nodal coordinates and edge directions are sufficient to determine aspect ratio, taper ratio and skew angle. The four edge length equations, two diagonal length equations, two area equations and one of the distortion measure equations are sufficient to simultaneously solve for each of the eight coordinate values in terms of the given distortion measure. Thus, the strain-displacement matrix and the determinant of the Jacobian matrix of the stiffness matrix may be formulated in terms of a given distortion measure instead of the x and y element coordinates. These equations reveal the effects of a given distortion (e.g. aspect ratio) on the element stiffness matrix because the stiffness matrix is expressed as a function of the distortion measure. This in turn reveals the effects on the deformation patterns and the strain energy content of the element in terms of the distortion measure.

Eqns. 5-20 may be solved to directly obtain the desired results only in the linear region. For large deformations and strains, no closed form solution exists and nonlinear solution techniques must be employed. The preferred approach is to empirically derive the desired results using an existing FE code that handles large deformation and strain problems.

Because large deformations and strains cause a FE problem to be nonlinear, no nice closed form mathematical solution is possible. An empirical approach to deriving the rezoning indicators via eigenvalue testing is therefore required.

In this empirical method, an eigenvalue test is first be run on an assumed ideal quadrilateral element. The normalized eigenvectors and their eigenvalues are then obtained for each mode. These are then summed over all the modes. The resulting value is the amount of strain energy for an ideal element for a given load vector. Eqn. 15 is suitable for this purpose. The next step is to repeat the same procedure for an element with a known distortion. Any one distortion measure is sufficient to separate the effects of that particular type of distortion. This also simplifies the interpretation of the data. The strain energy for the distorted element is obtained from Eqn. 15.

To obtain the relationship between the two values of strain energy, it is useful to compute the strain energy density for both the ideal and distorted elements instead of the strain energy alone. Distorting elements of unit area under controlled conditions simplifies the procedure to obtain the strain energy density values. Applying specified displacements to the element to maintain a given type of distortion is a simple matter. Because plastic deformation is assumed to be incompressible, the area of the element can always be maintained at a value of one no matter how extreme the distortion. This provides for a “normalized” comparison and yields the strain energy density because the volume is also of unit dimension. For axisymmetrical cases, however, the revolved volume must be accounted for. The ratio of the strain energy density of the distorted element to that of the ideal element serves as an excellent comparison.

If the type of distortion is maintained but varied in degree then a range of comparative values may be obtained. For example, the aspect ratio alone may be varied from a one-to-one value up to, for example, a forty-to-one value. In an empirical approach no function exists to generate a smooth continuous representation of the strain energy density ratios versus the range of a given distortion measure. Individual data points must be obtained and then a curve fit between these values to obtain the intermediate values.

It is assumed that discontinuities seen in plots of the data represent points at which an increase in the amount of distortion to the element significantly increases the error in the solution process. This identifies the limit on the amount of distortion an element can handle before the amount of error gets out of hand. This limit value is the distortion or rezoning indicator for the given distortion measure being used.

The theoretical basis for the eigenvalue test is a direct extension of a normal modes analysis. In normal modes analysis, the natural frequencies and mode shapes of an unconstrained object are desired. These quantities provide important information concerning the deformation and vibrational characteristics of a given structure. If this is reduced to a single element instead of a mesh of elements representing a structure, then theoretically, information that once identified the deformation modes and natural frequencies of a structure now does this for a single element. This is important because the possible modes of deformation and natural frequencies of a single element are available from this. A study can therefore be made on an element to element basis. This is essential to the rezoning process because each individual element must be examined instead of the entire mesh. Rezoning is associated with the remeshing of localized problems within the mesh cause by a single element or groups of elements.

In a normal modes analysis, the eigenvalue problem involving the stiffness and mass matrices is solved. The solution generally yields the square of the natural frequency for each mode. Using these values and a set of equations, the eigenvectors or mode shapes may be obtained. The eigenvectors describe a normalized deformation pattern for a given mode. The summation of these deformation modes describes the overall deformation pattern. For eigenvalue testing the interest is in just the stiffness matrix. In eigenvalue testing the mass matrix as seen in the normal modes equation is set equal to an identity matrix. The procedure is then identical to that of the normal modes solution.

An assumption is made that if the normal modes analysis technique is changed ever so slightly to become an eigenvalue test, that the eigenvalue test might reveal the deformation characteristics and strain energy content of the element. The eigenvalues and eigenvectors end up being related to the strain energy of the element and the eigenvectors are also related to the possible deformation patterns.

The eigenvector and eigenvalue for each mode makes a contribution to the overall deformation and to the amount of strain energy. In essence it is the summation of these values that determines the given deformation pattern in the element as well as its strain energy content. Eqns. 5-20 used in eigenvalue testing are described above. An eigenvalue test can therefore generate quantities that physically describe the deformation modes and strain energy associated with a given element. These in turn may be used to test the nature of the element under various distortions.

A number of eigenvalues and eigenvectors equal the number of degrees of freedom at each node times the number of nodes are extracted. There are three rigid body modes and five displacement modes for plane strain and plane stress elements. One rigid body mode and six displacement modes for axisymmetric elements. In some cases deformation modes appear in mirror images with equal eigenvalues.

Generally an eigenvalue test is used to check that an element's stiffness matrix provides as many rigid body modes as is expected. If too few are found, this suggests that the element lacks the desired capability for rigid body motion without strain. Too many suggests the presence of other mechanisms. These results should be independent of where or how the element is located and oriented in global coordinates. Instabilities in the stiffness matrix may also be determine by the eigenvalue test. These characteristic quantities of an eigenvalue test tend to validate the assumption that eigenvalue testing an element can detect when an element is behaving poorly because of improper deformation modes caused by distortions of the element.

Eigenvalue testing can be said to test the quality of the stiffness matrix. The stiffness matrix is derived in part from the element shape functions. These shape functions are implemented to properly represent the deformation and strain energy characteristics of the object modeled by the FE analysis. The shape functions are related to the geometry of the element and its expected deformation patterns. If the physical geometry of the element is distorted, this distortion is assumed to directly change the parameters used in the shape functions. This in turn affects the stiffness matrix which affects the possible deformation patterns and strain energy content of the element. Theoretically, the strain energy values of a distorted element must differ from those values for the corresponding ideal element.

The quantitative value of geometric distortion that may be applied to an element can be determined by examination of the range of values of strain energy density ratios of distorted elements to that of ideal elements. The idea is to determine a discontinuity in the pattern of change in the strain energy density ratios over a range of changing element distortion. For example, changes in the strain energy density ratios are examined with respect to just the change in one element distortion measure such as aspect ratio. This would be examined from an ideal value of aspect ratio to that of an extreme aspect ratio value. A discontinuity such as a difference in the rate of change of strain energy density ratio values is assumed to indicate the point where the distortions in the element cause errors in the solution that are too large to ignore. This is the basic assumption to quantify distortion measures to derive rezoning indicators. The values of the distortion measures, such as aspect ratio, at the point of the discontinuity are then defined to be the rezoning indicators.

The inventor implemented the methodology described above to derive rezoning indicators from eigenvalue tests. Several techniques were attempted until a workable solution was obtained. First, a simple case was examined, that of a one dimensional bar element being loaded axially. The simple problem was used to demonstrate the relationships between eigenvalue testing, deformation patterns and strain energy content. Next, the FE software MSC/PAL2 [MSC Software Corporation, 2 MacArthur Place, Santa Ana, Calif. 92707 USA] was used to run some normal modes case studies of single quadrilateral elements. Attempts were made to distort the element's shape from the ideal shape and note any differences in the natural frequency values and especially any differences in the shapes of the normal modes. This technique proved interesting but inconclusive as to the ability to distinguish any effect of the geometrical distortion on the element. Changes were noticeable but the results were inconsistent and thus no conclusion could be drawn.

Another approach attempted to determine rezoning indicators from the results of an eigenvalue test using Eqns. 15-16. The data required to calculate the strain energy density ratios, as given in Eqn 16 is accomplished by running the normal modes program in the ABAQUS FE code. First order elements in ABAQUS use lump mass at the node points. Care was taken to select density values so that the mass matrix became the identity matrix and the eigenvalue problem of Eqn. 7 becomes the equation to solve. At this point the normal modes procedure of ABAQUS becomes identical to an eigenvalue test procedure. ABAQUS uses the subspace iteration method so all possible modes are obtained. Only unconstrained cases were considered.

To run the eigenvalue tests in ABAQUS a material had to be chosen to be able to input the required values to compute the stiffness matrix. A standard high strength steel was chosen. Assumptions as to the material values such as the elastic modulus had to be made. For metals these values are similar for a large variety of metals and thus was not a difficult choice.

Data is gathered by restricting each eigenvalue test run to a particular geometrical distortion. Examination of just aspect ratio, just skew angle, or just taper ratio is implemented to study the effects of just one distortion parameter at a time. An idealized element model is also solved for the comparison purposes essential to Eqn. 16. Unit area elements are used throughout the process.

ABAQUS was used to perform the eigenvalue tests. The input file was formulated to obtain the eigenvalues and eigenvectors for the range of distortion measures being considered. Initially an ideal element is formulated in the model. An eigenvalue test is then performed on the unconstrained ideal element. The next step is to use applied displacements on the element to plastically deform the element to the desired distortion measure. An area of unit dimensions is maintained by controlling the values of applied displacement. At this point the reaction forces are obtained and used as the load vector in Eqns. 15-16. The applied displacements are then released. The element then relaxes by the amount of elastic recovery. This amount of relaxation is negligible in comparison to the permanent deformation cause by plastic straining. The error in the distortion measure caused by this relaxation is negligible. At this point an eigenvalue test is performed on the unconstrained, plastically deformed element of a given distortion measure. This yields the eigenvalues and eigenvectors for the given distortion. Applied displacements are again placed upon the element to achieve the next increment in distortion value. The process repeats itself and continues for all the desired values of the distortion measure. This process is performed for each of the distortion measures selected for the remeshing process.

Plane strain, plane stress and axisymmetric elements are the elements of consideration. All distortions are assumed to take place upon an ideally shaped element that has edges that are aligned with the x and y coordinate axes. An aspect ratio is determined by elongating both of the element's edges running in the x direction by equal amounts while the other two edges vary equally in the y direction to maintain an area of unit dimension yet arrive at the desired aspect ratio. Aspect ratios of 1, 2, 4, 0.6, 8, 10, 12, 14, 16, 18, 20, 22.5, 25, 30, 35 and 40 to 1 are used.

This method of achieving the aspect ratios maintains a rectangular shaped element throughout the entire range of aspect ratio values. This focuses the study of distortion effects to just the aspect ratio distortion measure. No taper ratio or skew angle effects are included.

To achieve the range of taper ratios, the upper element edge is consecutively reduced in length while the lower element edge is proportionally increased in length. This change is symmetric about a vertical axis. An area of unit dimension is held for each value of taper ratio. The element's vertical height to the length of its lower edge is maintained to be equal distances. Taper ratios of 1.0, 0.9, 0.8, 0.7, 0.6, 0.5, 0.4, 0.3, 0.2 and 0.1 are used.

The method of achieving the taper ratio is certainly not a totally inclusive way to achieve these values. Taper ratio maintains ties to skew angle and aspect ratio. The method used was chosen as one of the best ways to achieve a given taper ratio and yet reduce the effects of skew angle and aspect ratio. Like aspect ratio the idea is to isolate the effect of taper ratio to be able to quantify its affect alone.

For skew angle the interior angle of two opposite element corners were equally reduced for each run while the other two opposing element corner angles were equally increased. Each edge length changed in equal proportion to achieve an area of unit dimension for any prescribed skew angle value. The element for each skew angle is held symmetric about a forty-five (45) degree angle in the x-y coordinate plane. Skew angles of 90, 80, 70, 60, 50, 40, 30, 20 and 10 degrees are used.

Just like the taper ratio the manner in which the skew angle is achieve is not all encompassing. It does however, generate results that are typical of skew angles no matter how the skew angle is determined. Several different approaches were examined and the results tend to indicate that the manner in which the skew angle was achieved is representative of the majority of possible cases.

The data gathered from the eigenvalue test is manipulated and put in the form of Eqns. 15-16. The values for the ratio of distorted elements strain energy density to that of an ideal element versus the distortion criteria were gathered over the ranges previously stated. Various curve fitting programs were examined. A least squares polynomial fit, a cubic spline fit, a linear fit and a Lagrange polynomial fit were tried. Along with the fit, derivatives and the sensitivity of the curves were also determined. The derivatives and sensitivity of the values help indicate the discontinuities and therefore determine the rezoning indicators. The sensitivity plot is also used to examine how sensitive the strain energy density ratio, Equation (4.11), is to a change in a given distortion measure.

A cubic spline curve fit was chosen because it most closely matches the data while maintaining continuous derivatives across each of the data points. This is important when selecting the rezoning indicators based on a possible discontinuity in the curve or surface. If discontinuities arise from the particular curve or surface fit used, then the determination of the rezoning indicators may not be possible,

The rezoning indicators discovered by the inventor from the results of these eigenvalue tests are summarized in tabular form in Table 4.1. These values were chosen based upon different types of plots that were developed to evaluate the strain energy density ratio versus a given range of the various distortion measures. A value was determined for each type of distortion measure for each type of element that was studied. It is interesting to note that the values for all three element types, axisymmetric, plane strain and plane stress are very close in value. This implies that the general similarities exist because all the element are quadrilateral elements. Slight differences might result from the differences in assumptions used in forming the element such as an axis of symmetry condition.

TABLE 4.1
Rezoning indicators

| | |
|---|---|
| ELEMENT TYPE | VALUE |

ASPECT RATIO REZONING INDICATORS

| | |
|---|---|
| Plane Strain | 18.59 |
| Plane Stress | 16.80 |
| Axisymmetric | 18.38 |

TAPER RATIO REZONING INDICATORS

| | |
|---|---|
| Plane Strain | 0.58 |
| Plane Stress | 0.63 |
| Axisymmetric | 0.55 |

SKEW ANGLE REZONING INDICATORS

| ELEMENT TYPE | MIN VALUE | MAX VALUE |
|---|---|---|
| Plane Strain | 43 | 137 |
| Plane Stress | 52 | 128 |
| Axisymmetric | 50 | 130 |

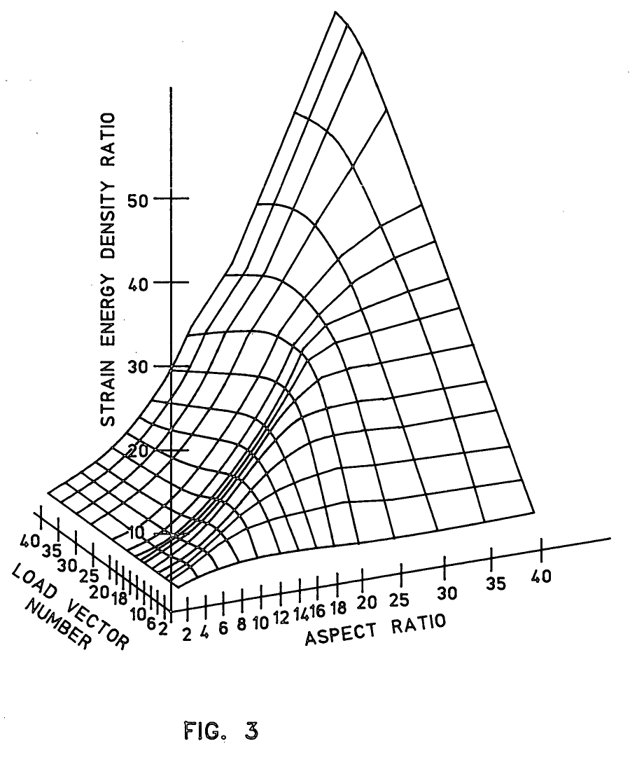

The rezoning indicators were derived by examination of four plots of the results obtained through eigenvalue testing. A 3-D plot is generated that examines the relationship between the range of a given distortion measure, the derived strain energy density ratio values and the load vectors obtained for each applied displacement representative of a given distortion measure. In this plot the third dimension was added to gain insight into how a different load vector might effect the results of Eqn. 16. This surface plot illustrates the full effect of Eqn. 16. FIG. 3 provides an exemplary 3-D plot of strain energy density ratio varied over aspect ratio and load vector values for an axisymmetric quad element.

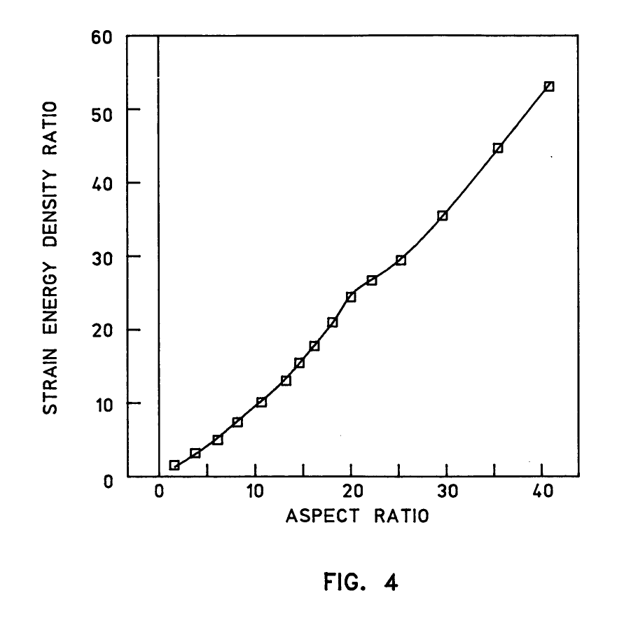

The 2-D plot of strain energy density ratio versus a range of values of a given distortion measure is also of interest. This is equivalent to the diagonal of the corresponding 3-D surface plot with a single load vector used for a given distortion measure. The load vector used corresponds to the resultant loads obtained by the applied displacements that plastically deformed the element to the shape of the desired distortion measure. FIG. 4 provides an exemplary 2-D plot of strain energy density ratio versus aspect ratio for an axisymmetric quad element.

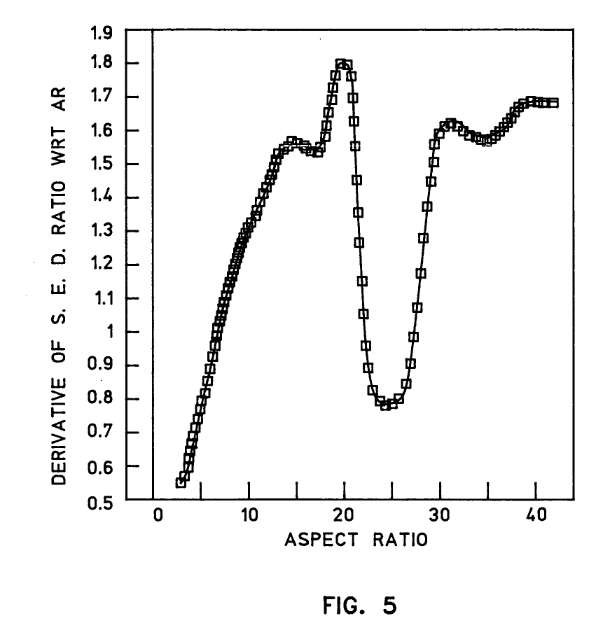

The derivative of the strain energy density ratio versus the given distortion measure is also of interest for finding discontinuities in the results of the eigenvalue tests. This shows the derivative of the 2-D plot exemplified by FIG. 4 and more clearly illustrates the point at which any discontinuity occurs, thereby better quantifying the rezoning indicator value. FIG. 5 provides an exemplary plot of the derivative of strain energy density ratio with respect to aspect ratio versus aspect ratio for an axisymmetric quad element.

The sensitivity of the strain energy density ratio versus a given distortion measure is also a useful plot, which is closely related to the derivative plot of FIG. 5 except that the sensitivity equation contains terms additional to the derivative. The equation for the sensitivity of the strain energy density ratio to a change in the aspect ratio is given by

$${S}_{AR}^{\overline{U}} = \frac{AR}{\overline{U}} \frac{ⅆ \overline{U}}{ⅆ AR} \qquad [ Eqn . 21 ]$$

where AR represents aspect ratio as a variable. The sensitivity for taper ratio is given by

$${S}_{TR}^{\overline{U}} = \frac{TR}{\overline{U}} \frac{ⅆ \overline{U}}{ⅆ TR} \qquad [ Eqn . 22 ]$$

where TR represents taper ratio as a variable. The sensitivity for the skew angle is given by

$${S}_{SK}^{\overline{U}} = \frac{SK}{\overline{U}} \frac{ⅆ \overline{U}}{ⅆ SK} \qquad [ Eqn . 23 ]$$

where SK represents skew angle as a variable.

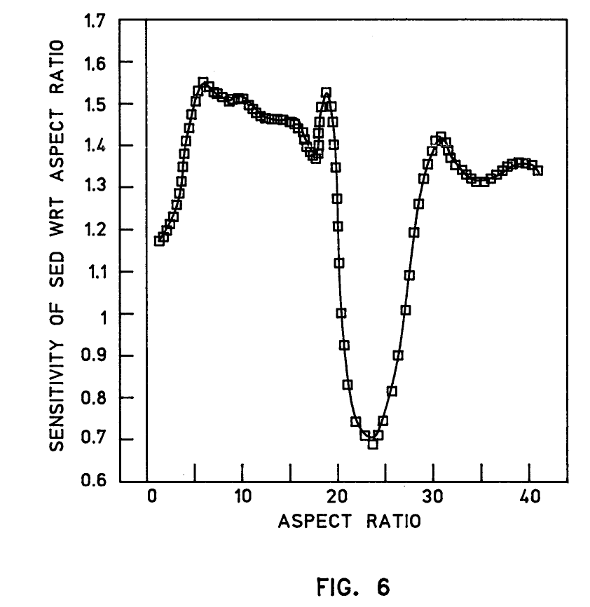

The sensitivity plot is another technique used to quantify a given rezoning indicators value. This type of plot illustrates the relative sensitivity of a quantity to any degree of change. The more the amount of change the more dramatic this is illustrated in a sensitivity plot. The plots can therefore tune in on discontinuities. Any discontinuity in the plot of strain energy density ratio versus a given distortion measure shows up as a dramatic change in the nature of the sensitivity plot. FIG. 6 provides an example of the sensitivity of strain energy density ratio with respect to aspect ratio versus aspect ratio for an axisymmetric quad element.

Each of these four plots aid the others in attempting to determine where the discontinuities occur and hence the value of the rezoning indicator. In some cases, but not all, at least two or more of these plots needed to be correlated to quantify the rezoning indicator values. Correlation of all four plots the same point of a given distortion measure confirms the validity and usefulness of the rezoning indicator value.

The state variable gradient differentials or contours provide information as to when, where and how much rezoning should be done. The gradient differentials may not only indicate the elements that need to be reshaped but the regions of the mesh that need refinement as well. Generally this is accomplished via an h-type refinement. The refinement in the mesh helps to smooth out the discontinuities and provides more elements in areas of steep gradients thus assisting in the avoidance of numerical difficulties and solution inaccuracies.

The benefit of using these rezoning measures is that the information is directly available from the results of the solution. Contour plots make a visual inspection of these quantities and location of steep gradients possible. Examination of the data can determine the magnitude of the jumps in the values. Often this corresponds with the areas of steep gradients.

Correlation of the results obtained from jumps and steep gradients of displacement, strain, stress and strain energy density to the rezoning indicators derived from eigenvalue tests was found to validate the rezoning indicators of this invention.

The Remeshing Procedure

The remeshing procedure required for the rezoning process of this invention is now described. In the rezoning process, the solution is halted and a new optimized mesh is created in the region of the distorted elements. This eliminates the distorted elements that create the inaccuracies and ill-conditioning in the solution process.

The process described above for remapping element variables from an old mesh to the new mesh is as important to the rezoning process as the remeshing itself. Interpolation of the element variables may be required to restart the FE solution process after remeshing.

The mesh manipulation procedure or remeshing process of the rezoner provides the means to generate a new mesh filled with valid and well shaped elements. The rezoning indicators serve as identifiers of regions to be rezoned as well as how the rezoning should take place within that region. The region may be rezoned by reshaping the existing elements, refining the mesh in the region, or by a combination of both. Generally, the region is selected so that the boundary to this region is surrounded by existing valid elements that remain valid and undistorted for some number of time increments further along the solution process. This helps to reduce the number of rezonings required. This process permits elements near distortion to be reshaped and thus be usable in an increased number of time increments than if left unrezoned.

Once the mesh region to be rezoned has been identified than a meshing technique is implemented to generate the new mesh. The form, shape and number of elements of the new mesh is generated by the values of the rezoning indicators when compared to the past, present and future states of deformation in the elements.

FE mesh manipulation or remeshing can be accomplished by means of any well-known useful method such as transfinite, Laplacian, isoparametric and conformal mapping, for example. Other examples include subdivision by quadtree encoding, a least squares method and various ad hoc meshing methods.

One technique that has received much attention and is very powerful is that of non-uniform rational b-splines (NURBS). NURBS may be used not only to generate sculptured surfaces, but the technique has the ability to fit a given set of data. A combination of these qualities is required in a remeshing scheme. The new mesh must be fitted into a region of existing nodes and elements. A match up to the nodes and elements that are present and not part of the rezoning process is an essential requirement. A fit to existing node points is therefore required. A mesh must formed within the boundary defined by these nodes of the old mesh that were not included in the rezoning process. In this case the sculptured surface creation techniques of NURBS comes in handy.

NURBS have the properties of allowing local changes within a surface without effecting the rest of the surface. This allows the use of NURBS to locally move nodes about to optimize the shape of the remeshed region. NURBS generally follows the shape of the defining polygon, that is they exhibit strong convex hull properties. They may therefore be effective in matching up to the existing nodes and elements. The order of the fit is only limited by the number of points given in the definition of the NURBS surface. This allows for meshing of complex regions.

The determination of the where and how to remesh a given region of a FE mesh, may in most cases be controlled by the rezoning indicators. This is not always the case but a few simple rules may be implemented where the rezoning indicators can be used in the majority of the cases of remeshing elements that are flagged for rezoning.

First, it is desired that the new mesh be better than the previous mesh. Furthermore, it is desired that the region of the new mesh not require rezoning only after a couple of increments or time steps. This may not be possible in regions that involve a great amount of change on a constant basis. The rezoning process should still provide the best mesh for the given situation.

The region of rezoning must at a minimum cover all the distorted elements. Numerous localized regions or entire sections of the mesh may be considered. As a rule of thumb those elements that surround the distorted elements and surround those elements that are close to or approaching the limits set by the rezoning indicators, but do not fall into this category, should form the boundary of the mesh rezoning region. According to Saint Venant's principle the effect of a poor element is localized. As long as the local region of its effect is remeshed correctly then proper rezoning has taken place. The idea is to obtain a rezoning region of the mesh where the boundary nodes and elements to the region behave properly. When this region extends to the physical boundary of the mesh then this physical boundary must be maintained during the rezoning. Nodes and elements can shift along the boundary but must adhere to this physical dimension.

The amount of reshaping of the elements and refinement of the mesh is determined from the rezoning indicators. In some instances the physical geometry of the problem or the remeshing technique used may prohibit the amount of rezoning specified by the rezoning indicators. In this regards it is important to build in rules that apply to such cases. Generally, the indicators measure the amount of rezoning to be done and the remeshing technique employed should stay with in those bounds. When difficulties arise in this type of situation, the region of rezoning may be enlarged to include more of the valid elements if possible. This increases the total rezoning region in an effort to overcome any remeshing difficulties. Another solution is stay with in the specified regions but refine the mesh. Increasing the number of elements in a given region may also aid in overcoming remeshing difficulties.

A key feature to the rezoning process is the ability to access and change the model database. First, access is required to examine the FE mesh. Second, the newly rezoned regions into the FE model must be updated as the rezoning process proceeds. This means the deletion, creation and movement of nodes and elements while still maintaining the linking relationships between the nodes and elements of the mesh. Generally a renumbering and relabeling of the nodes and elements are required. The old mesh and its nodal and element values must also be stored as part of the rezoning process so that a comparison and remapping of the element variables can occur.

The remeshing technique described in this chapter may be effectively used in a self-adaptive rezoning procedure. As mentioned above, the software implementation of such an procedure requires the use of a well-known expert system to handle the “judgements” needed to optimize the remeshing phase of self-adaptive rezoning. Each remeshing sequence of the rezoning process calls for a unique new mesh to be created. This, in combination with the infinite number and types of problems that involve rezoning, calls for a remeshing procedure that has artificial intelligence, which may be implemented without undue experimentation in view of these teachings.

Using the rezoning indicators to determine the regions of the mesh to be remeshed is fairly straightforward. Determining exactly how to optimally generate the new mesh in the rezoning region is more complex. Variables from the old mesh must properly transfer to the new mesh based on the layout of the new mesh instead of the remapping procedure. The important part is that this information is not only gathered for the present state but also for future states and even past states of deformation. The data supplies information on the patterns of deformation within the mesh throughout a given portion of the solution. These data may therefore be used for information on how and when elements become distorted. This allows an expert system to optimize the new mesh region.

The Remapping Procedure

The final step of the rezoning process of this invention is to remap the nodal and element variables from the old mesh onto the new mesh. The FE solution process is then restarted at the time increment at which it was halted fro rezoning.

Most remapping techniques use some type of interpolation, least squares fit or weighted parameters based on the position of the old mesh to that of the new mesh. The remapping process restores the values of the element variables at the new locations. Generally if the interpolation scheme used is based on the same interpolation function of the elements then the procedure works well. Remapping need only occur in the mesh regions that received changes from the rezoning process and not over the entire mesh.

Some FE codes, which include interactive rezoners, have procedures which allow the remapping or interpolation of the old mesh to the new mesh. It is clearly advantageous to use a built in remapper if it is available and deemed to be appropriate. In most cases these remapping schemes are created to provide the best remapping possible for the given mesh with consideration to computational effort. The remapping scheme in ABAQUS' FE code are useful examples.

The interpolation or remapping technique used in ABAQUS is as follows. All element variables must be obtained at the nodal locations. This is done by extrapolating all the values from the integration points to the nodes and then averaging the values of all the elements that interface at that given node. The integration points of the new mesh are then determined with respect to the nodes of the old mesh. The element in which a old mesh nodal point lies is found and its location in new element is determined. The variables are then interpolated from the node of the old mesh to the integration point or points of the new element. All the variables are automatically interpolated within the ABAQUS code. This is true for quasi static problems. The remapping technique, however, was not implemented in ABAQUS for dynamic problems. Dynamic problems, therefore require the user to remap dynamic related variables such as the velocities. For dynamic problems the strains and stresses are still remapped automatically.

Like many visual post processing results that average variables at the nodes, remapping techniques that do likewise may in fact be smoothing over discontinuities in the solution. This very technique may introduce inaccuracies into the solution, requiring caution. The inaccuracies generally occur only where the jumps or discontinuities at the nodal points are of extreme relative value. The rezoning process itself can continually correct the mesh to avoid such extremes in values. The values averaged at the nodal points are then relatively small. Proper and timely rezoning avoids the possible “smoothing over” of discontinuities during the remapping phase.

As previously mentioned, when jumps or discontinuities in element values appear in the newly remapped region, this is an indication of either improper interpolation of the variables during remapping or that improper, insufficient or belated rezoning has occurred. Either the element shapes were improper or more than likely the mesh was insufficiently refined. Lack of refinement is usually associated with discontinuities in the solution. On the other hand the rezoning process can be applied too late, letting too much distortion take place within the elements. A combination of these effects is also possible.

A quality control on the rezoning process may be achieved by examining the element variables in the newly remapped region. This process may itself provide a useful rezoning indicator. If this quality control indicator (the check for discontinuities in variables at the nodal locations) determines that there are discontinuities, then rezoning process has failed and must be repeated, perhaps with a rollback of a few time increments. This assumes that the discontinuities are not caused by the remapping or interpolation of variables but actually reflect uncorrected element distortion. Such a quality control process may also suggest a change to the time increment size.

Summary

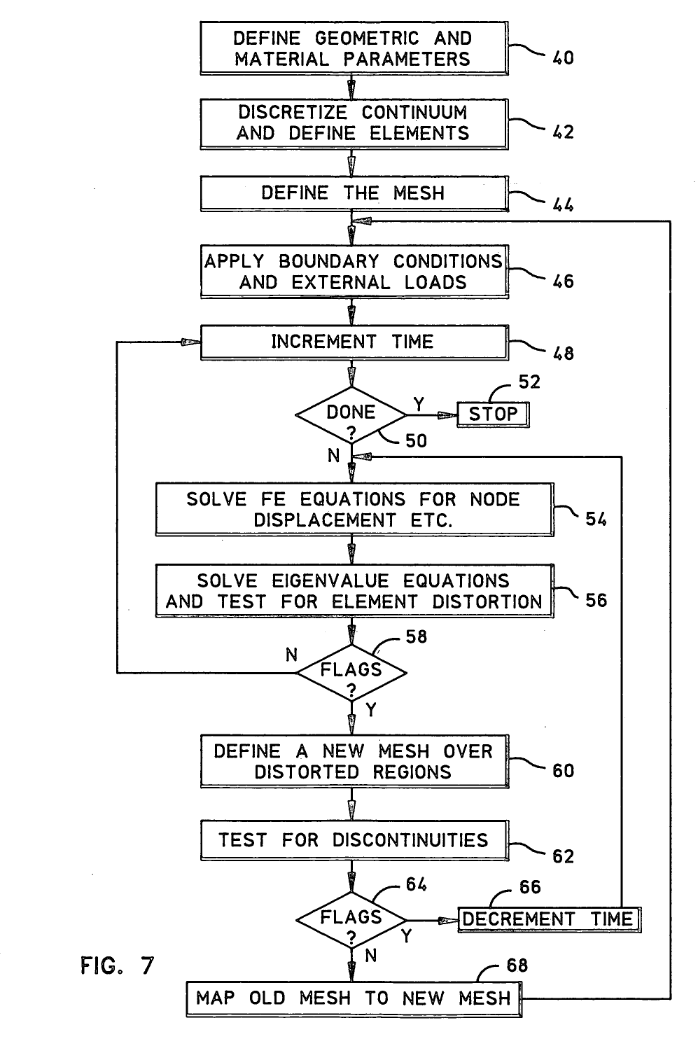

FIG. 7 is a block diagram illustrating the adaptive rezoning process of this invention applied to the FE analysis of a continuum having a boundary (an object). The details of each of the following steps are discussed sufficiently herein above to permit the practice of this invention by any and all skilled in the art without undue experimentation. In the first step 40, the geometric and material parameters are defined for the continuum and boundary. In the step 42, the continuum is discretized and the elements intended for use in the FE analysis are defined. The initial mesh is defined over the continuum in the next step 44 and the external boundary conditions are applied to the object boundary in the step 46. The first time increment is taken at the next step 48 and the new value of the time variable is tested at the step 50 to determine if the FE analysis is completed. If complete, the process halts at the step 52; if not, then the usual system of FE equations is solved in the step 54 to generate the new strain and displacement values for every node in the mesh.

At this point, the adaptive remeshing process begins by solving for the eigenvalues and eigenvectors for the elements in the step 56 to generate an element distortion measure for each element. This process is repeated for each of the distortion measures selected for the remeshing process and the elements for which the resulting distortion measure exceeds a predetermined threshold are flagged. In the next step 58, the flagged elements are accumulated to form regions of distortion that are in need of remeshing in accordance with the process of this invention. If no such regions are identified, the procedure returns to step 48 and iterates as shown. If one or more distorted regions are identified, the next step 60 generates a new mesh over the distorted region(s) using any useful meshing procedure known in the art without limitation. In the next step 62, the new mesh is examined for the presence of discontinuities in the manner detailed herein above and regions with discontinuities are flagged for reprocessing. In the step 64, the flagged regions are either remeshed in step 60 (not shown) of the time increment is rolled back in the step 66 and the procedure returned to step 54 for a rolled back FE solution for the reasons set forth herein above. Finally, after verifying a suitable new mesh in step 64, the old mesh is mapped into the new mesh in the step 68 and the process returns to step 46 for a continuation of the basic FE analysis.

Clearly, other embodiments and modifications of this invention may occur readily to those of ordinary skill in the art in view of these teachings. Therefore, this invention is to be limited only by the following claims, which include all such embodiments and modifications when viewed in conjunction with the above specification and accompanying drawing.

It will be understood that many additional changes in the details, materials, steps and arrangement of parts, which have been herein described and illustrated to explain the nature of the invention, may be made by those skilled in the art within the principal and scope of the invention as expressed in the appended claims.

I claim:

1. A machine-implemented adaptive rezoning process for implementation in a finite element (FE) analysis process for analyzing a continuum having a boundary, including the steps of (a) defining geometric and material parameters, (b) discretizing the continuum, (c) defining the element properties and geometry, (d) defining an initial mesh of nodes coupled by the elements, (e) applying boundary conditions and material parameters to the initial mesh, and (f) solving a system of simultaneous equations to find the strain displacements of a plurality of the mesh nodes as a function of a time increment, the adaptive rezoning process comprising the steps of:
(g) generating a plurality of eigenvalues responsive to a machine-implemented solution of a plurality of element eigenvalue equations;
(h) generating an element distortion measure at a first mesh node responsive to the plurality of eigenvalues;
(j) defining a new mesh over at least one region in the continuum responsive to the first mesh node distortion measure;
(k) generating a discontinuity measure for the new mesh;
(l) repeating the defining step (j) and the generating step (k) if the discontinuity measure exceeds a second predetermined threshold; and
(m) mapping the initial mesh to the new mesh.
